(19) United States
(12) Patent Application Publication
(10) Pub. No.: US 2009/0164291 A1
(43) Pub. Date: Jun. 25, 2009

(54) Methods and Systems for Evaluating Outsourcing Potential

(75) Inventors: Yogesh Shah, Dunwoody, GA (US); Krishnamoorthy Srinivasan, Marietta, GA (US); Willa Fabian, Sandy Springs, GA (US)

Correspondence Address: CROSE LAW LLC, 112 NORTHBROOKE TRACE, WOODSTOCK, GA, 30188, US

(73) Assignee: COMPUCREDIT CORPORATION, Atlanta, GA (US)

(21) Appl. No.: 11/963,205

(22) Filed: Dec. 21, 2007

(51) Int. Cl. G06Q 10/00

(52) U.S. Cl. 705/9

(57) ABSTRACT

A system, method, and interactive computer program product are provided for interactively analyzing sourcing options for positions within an organization utilizing a multidimensional, multi-factor analysis. Additionally, this technology provides for evaluating positions in an organization, evaluating the potential for outsourcing, and determining from where to source candidates for the positions in an objective, timely, and cost-effective manner. The dimensions include short-term, tactical drivers and long-term, strategic drivers. The factors include intellectual property, customer facing, availability of skills in the local marketplace, flexibility, communications channels utilized, cost, duration, and organization readiness to procure externally sourced candidates. An interactive, on-screen interview questionnaire and coach is utilized. The system is reconfigurable on a per-client basis. Dimensions and factors are added as required and scales, factors weightings, and benchmark values are adjustable by a user.

### FIELD OF THE INVENTION

The technology described herein relates generally to employment sourcing. More specifically, this technology relates to systems and methods for evaluating positions in an organization, evaluating the potential for outsourcing, and determining from where to source candidates for the positions in an objective, timely, and cost-effective manner. Additionally, this technology relates to an interactive toolkit for multidimensional and multi-factor weighted analysis of sourcing options.

### BACKGROUND OF THE INVENTION

In order to maintain a competitive advantage in the global marketplace, it is vital for a business to continually review its options for employment sourcing. Such a review of options for employment sourcing often includes the conundrum of whether to outsource internal functions of the business currently being performed by company employees to an outsourcing vendor. These internal functions are not limited to any specific business functional area and include, for example, services, research, development, and manufacturing.

A myriad of business drivers exist behind this challenge of whether to outsource internal functions of the business, ranging from, for example but not limited to, cost cutting, access to proven processes, and resilience to attrition. The evaluation of whether a business function can be, or should be, outsourced is often an extremely laborious exercise. It is critical that this sourcing review be done in an objective, cost-effective, and timely manner to attain the appropriate business value. It is equally important that such a review of employment sourcing includes the flexibility to adjust the business drivers relevant to the business and to the positions being evaluated.

The following published patent applications are known in the art. U.S. Patent Application Publication No. 2007/0162321, filed by Behrmann et al. and published on Jul. 12, 2007, discloses a method for the outsourcing of services. U.S. Patent Application Publication No. 2005/0159992, filed by Lawrence et al. and published on Jul. 21, 2005, discloses a process for identifying potential customers for business outsourcing. U.S. Patent Application Publication No. 2006/0064336, filed by Cereseto et al. and published on Mar. 23, 2006, discloses a method and system for facilitating electronic outsourcing value assessment. U.S. Patent Application Publication No. 2005/0060224, filed by Ricketts and published on Mar. 17, 2005, discloses a simulation of business transformation outsourcing. U.S. Patent Application Publication No. 2001/0051913, filed by Vashistha et al. and published on Dec. 13, 2001, discloses a method and system for outsourcing information technology projects and services. U.S. Patent Application Publication No. 2006/0080156, filed by Baughn et al. and published on Apr. 13, 2006, discloses an outsourcing command center. U.S. Patent Application Publication No. 2007/0038502, filed by Kagan et al. and published on Feb. 15, 2007, discloses an efficient frontier and attainment rate for business transformation outsourcing.

The foregoing patent information reflects the state of the art of which the inventors are aware and is tendered with a view toward discharging the inventors' acknowledged duty of candor in disclosing information that may be pertinent to the patentability of the technology described herein. It is respectfully stipulated, however, that the foregoing patents do not teach or render obvious, singly or when considered in combination, the inventors' claimed invention.

### BRIEF SUMMARY OF THE INVENTION

In various exemplary embodiments, the technology described herein provides systems and methods for evaluating positions in an organization, evaluating the potential for outsourcing, and determining from where to source candidates for the positions in an objective, timely, and cost-effective manner. Additionally, this technology provides an interactive toolkit for multidimensional and multi-factor weighted analysis of sourcing options.

In one exemplary embodiment, the technology provides a computer readable storage medium encoded with programming for interactively analyzing sourcing options for positions within an organization in multiple dimensions. The programming is configured to receive a requisition identifying a position within an organization that is to be filled, evaluate the position based upon a first series of business factors, inquire whether the position requires a full-time employee, evaluate the position based upon a second series of business factors, rank the first series of business factors and the second series of business factors on a predetermined scale to quantify each factor's impact to the organization, calculate a single numerical value representative of the rank of each of the first series of business factors and the second series of business factors, compare the calculated value with a predetermined benchmark to determine a suitable sourcing option, and fill the position from a plurality of sourcing options based upon a result of the multidimensional, interactive sourcing analysis.

Within this embodiment the first series of business factors includes short-term, tactical drivers and long-term, strategic drivers. The second series of business factors includes intellectual property, customer facing, availability of skills in the local marketplace, flexibility, communications channels utilized, cost, duration, and organization readiness to procure externally sourced candidates.

The programming is further configured to utilize an interactive, on-screen interview questionnaire and coach a user as the user responds to the interactive, on-screen interview questionnaire. The programming is reconfigurable on a per-client basis. Additionally, the programming allows the addition of one or more first series of business factors and/or the addition of one or more second series of business factors interactively by a user based on a particular organization business driver currently unaddressed. A user can rescale the predetermined scale used to quantify each factor's impact to the organization, in response to business drivers. A user can also reconfigure the predetermined benchmark used determine a suitable sourcing option, in response to business drivers. The programming is further configured to calculate a single numerical value representative of the rank of each of the first series of business factors and the second series of business factors utilizing weighted averages and accept and review user-entered weighted values for each of the first series of business factors and the second series of business factors.

In another exemplary embodiment, the technology provides a method for evaluating outsourcing potential and interactively analyzing sourcing options for positions within an organization. The method includes receiving a requisition identifying a position within an organization that is to be filled, evaluating the position based upon a first series of business factors, inquiring whether the position requires a full-time employee, evaluating the position based upon a second series of business factors, ranking the first series of business factors and the second series of business factors on a predetermined scale to quantify each factor's impact to the organization, calculating a single numerical value representative of the rank of each of the first series of business factors and the second series of business factors, comparing the calculated value with a predetermined benchmark to determine a suitable sourcing option, and filling the position from a plurality of sourcing options based upon a result of the multidimensional, interactive sourcing analysis.

The method also includes utilizing a sourcing valuation algorithm residing in a computer program product to analyze sourcing options, utilizing an interactive, on-screen interview questionnaire, and coaching a user as the user responds to the interactive, on-screen interview questionnaire. As necessary, the method includes rescaling, by a user, the predetermined scale used to quantify each factor's impact to the organization, in response to business drivers and reconfiguring, by a user, the predetermined benchmark used determine a suitable sourcing option, in response to business drivers. The method also includes calculating a single numerical value representative of the rank of each of the first series of business factors and the second series of business factors utilizing weighted averages and accepting and reviewing user-entered weighted values for each of the first series of business factors and the second series of business factors.

In yet another exemplary embodiment, the technology provides a computer program product for interactively analyzing sourcing options for positions within an organization. The computer program product includes a computer readable storage medium readable by a processor of a computer and configured to store instructions for execution by the processor for performing a method illustrated in the flowcharts of FIGS. 1 to 3. This method includes receiving a requisition identifying a position within an organization that is to be filled, evaluating the position based upon a first series of business factors, inquiring whether the position requires a full-time employee, evaluating the position based upon a second series of business factors, ranking the first series of business factors and the second series of business factors on a predetermined scale to quantify each factor's impact to the organization, calculating a single numerical value representative of the rank of each of the first series of business factors and the second series of business factors, comparing the calculated value with a predetermined benchmark to determine a suitable sourcing option, and filling the position from a plurality of sourcing options based upon a result of the multidimensional, interactive sourcing analysis. The computer program product further includes logic configured to interview and coach a user with an interactive, on-screen interview questionnaire.

Advantageously, this technology provides a system, method, and interactive computer program product for interactively analyzing sourcing options for positions within an organization utilizing a multidimensional, multi-factor analysis. Additionally, this technology provides for evaluating positions in an organization, evaluating the potential for outsourcing, and determining from where to source candidates for the positions in an objective, timely, and cost-effective manner.

There has thus been outlined, rather broadly, the features of this technology in order that the detailed description that follows may be better understood, and in order that the present contribution to the art may be better appreciated. There are additional features of the invention that will be described and which will form the subject matter of the claims. Additional aspects and advantages of this technology will be apparent from the following detailed description of an exemplary embodiment which is illustrated in the accompanying drawings. The technology described is capable of other embodiments and of being practiced and carried out in various ways. Also, it is to be understood that the phraseology and terminology employed are for the purpose of description and should not be regarded as limiting.

### BRIEF DESCRIPTION OF THE DRAWINGS

The technology described herein is illustrated with reference to the various drawings, in which like reference numbers denote like system components and/or method steps, respectively, and in which:

FIG. 1 is a flowchart diagram illustrating a method for evaluating positions in an organization, evaluating the potential for outsourcing, and determining from where to source candidates for the positions in an objective, timely, and cost-effective manner, according to an exemplary embodiment of the technology;

FIG. 2 is a flowchart diagram illustrating dimensional analysis according to an exemplary embodiment of the technology;

FIG. 3 is flowchart diagram illustrating factors analysis according to an exemplary embodiment of the technology; and

FIG. 4 is a block diagram illustrating the general components of a computer according to an exemplary embodiment of the technology.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides systems and methods for evaluating positions in an organization, evaluating the potential for outsourcing, and determining from where to source candidates for the positions in an objective, timely, and cost-effective manner. Additionally, this technology provides an interactive toolkit for multidimensional and multi-factor weighted analysis of sourcing options.

A method is provided to evaluate positions in a business organization and to determine from where to source candidates to fill these positions. A position to be evaluated can be, for example but not limited to, an open position, a newly created position, or an existing position that is currently filled. For example, in one embodiment, candidates are obtained from various sources and, dependent on the analysis, are placed in-house as a full-time employee (FTE), outsourced on-site, outsourced offshore, etc. This sourcing valuation method reviews all positions using a unique, multidimensional process to determine a timely and cost-effective manner in which to source candidates for each position. The method also is applicable to sourcing for any position within any business unit or division within the organization.

The sourcing valuation method utilizes two dimensions, an agile dimension and a functional dimension, both used to evaluate the positions based on timing criteria specific to the business organization. The agile dimension is defined as a short-term, tactical approach, primarily focusing on sudden changes in business demand. For example, the agile dimension reviews how quickly a position needs to be filled. The functional dimension is defined as a long-term, strategic approach, primarily focusing on maintaining services, or the like, to meet business demand. For example, the functional dimension reviews the long term impact on the business organization based on how a particular position is sourced.

This sourcing valuation method also utilizes several factors to evaluate these positions. For example, in one embodiment, these factors include: intellectual property, customer facing, availability of skills in the local marketplace of the business, flexibility, communication channel, duration, cost, and readiness in procuring external sources. Throughout this disclosure a scale of one (1) to five (5) will be utilized, with a score of 1 representing a value most likely to result in a decision to not outsource. However, alternative scales are used in alternative embodiments, so long as the impact to the business sourcing valuation is quantifiable.

Evaluation of the intellectual property factor includes review of the contribution that a person potentially filling the position likely will add to the core competency of the business. This factor inquires, for example, “Does the activity of the position create any intellectual property value for the business?” A ranking of this factor is, for example, on a scale from heavy contribution (1) to no contribution (5). The heavier the contribution to the intellectual property of the business, the less likely the evaluated position should be outsourced.

Assessment of the customer facing factor includes review of the amount of customer (internal or external) interaction required for a position. This factor inquires, for example, “Do the activities of the position require frequent face-to-face meetings and interactions?” The greater the need for customer facing, ranging from heavy interaction (1) to no interaction (5), the less likely the position is suitable for outsourcing.

Evaluation of the availability of skills in the local marketplace includes review of the particular skills needed for a position and the availability of those skills in the local marketplace of the business. This factor inquires, for example, “Are the required skills for the position available locally?” and “Are the required skills for the position available offshore?” The greater the availability of the desired skills locally, ranging from unavailable or hard to secure locally (1) to easily available (5), the less likely the position is suitable for outsourcing.

Assessment of flexibility includes a review of the demand for the position. This factor inquires, for example, “What is the demand by applicants to fill this position?” The greater the demand for the position, ranging from predictable demand (1) to unpredictable demand (5), the less likely the position is suitable for outsourcing.

Evaluation of the communication channel includes review of the various communication channels utilized by a person filling the position. Some positions are solely verbal, while other positions are solely written. Perhaps most positions require a mix of both verbal and written communications. This factor inquires, for example, “What are the most frequent communications channels required for this position?” The greater the need for verbal communications, ranging from solely verbal (1) to solely written (5), the less likely the position is suitable for outsourcing.

Assessment of duration includes review of the term of the position. For example, a position that is needed to be filled indefinitely may be better suited for a full-time employee and a short-term position may be better suited to be filled by outsourcing. This factor inquires, for example, “Is the duration of the position for a short-term, such as less than six months?” The greater the duration of the work, ranging in scale from greater than one year (1) to a few days, weeks, or months (5), the less likely the position is suitable for outsourcing.

Assessment of cost includes a review of the costs associated with filling a position and maintaining the position. This factor inquires, for example, “Is cost a significant business driver to fill this position?” The less the cost to the business, ranging from not a concern (1) to a significant concern (5), the less likely the position is suitable for outsourcing. Thus, a high-cost position has a higher likelihood to be outsourced than does a low-cost position.

Evaluation of readiness in procuring external sources includes review of business readiness to seek services, or the like, from the global marketplace. This factor inquires, for example, “Does the business infrastructure allow services to readily be tasked offshore?” The less ready a business is to offshore a particular service, or other business operation, for a particular position, ranging from not ready (1) to very ready (5), the less likely the position is suitable for outsourcing.

The aforementioned factors are exemplary. However, as will be readily apparent to those persons of ordinary skill in the art, other factors are available for utilization in alternative embodiments. For example, dependent on the specific nature of a business, a business will review the repeatable processes used in any positions. If a particular service, or other business operation, includes well-documented and easily repeatable processes, the position is more likely a candidate position for sourcing the position offshore. In yet another alternative embodiment, a business will review the communication challenges, ranging from frequent interaction to infrequent interaction, in communications with outsourced resources and offshore resources.

For each dimension, agile and functional, the factors are given a rank utilizing a scale. As discussed in this disclosure the scale ranges from one to five. Rank 1 means that the responsibilities of the position need to be delivered by an employee of the company or a person working at the company's facilities, and rank 5 means that the responsibilities of the position can be delivered by a person working outside the company's facilities. The factors are assigned different weightings dependent on the business needs of a particular company. A weighted average for a position is calculated along the two dimensions, both agile and functional. A benchmark weighted average is established for the company and any position whose weighted average is above the benchmark average can be sourced from external sourcing partners for the company.

For example, in a two-dimensional, eight-factor analysis with a scale of one to five, summed scores will range anywhere from 16 to 80. A score of 16 represents a “1” response on each factor for each dimension. Such a score represents a position that is not at all suitable for external sourcing. A score of 80 represents a “5” response on each factor in each dimension. Such a score presents a position that is very suitable for external sourcing. Scores 17 through 79 are mathematically possibly in between the boundaries of the scale for scoring. A business will set its benchmark average somewhere in this range dependent on aspects of the business. As will be apparent to one or ordinary skill in the art, the scale and scoring method varies in alternative embodiments.

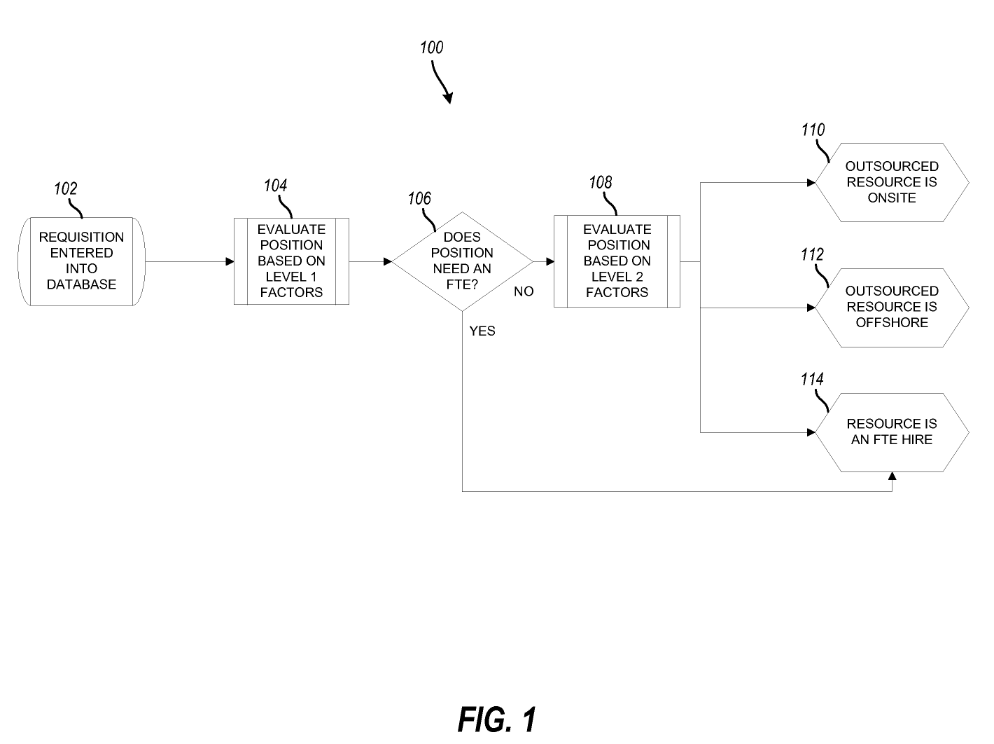

Referring now to FIG. 1, a method for evaluating sourcing potential 100 is shown. As a company learns of an internal position that needs to be filled, a requisition for that position is entered into a database 102 where positions are tracked and analyzed for sourcing potential. Utilizing an interactive toolkit, or the like, each position is evaluated against level 1 factors 104, or dimensions, such as the agile and functional dimensions as discussed above. The interactive toolkit inquires of a user whether the position needs to be filled by a full-time employee (FTE) 106. If the position needs to be filled by an FTE, the best resource to fill the position is an FTE hire 114 and not an outsourced resource. If the position does not need to be filled by an FTE, the position is evaluated based upon level 2 factors 108. Dependent upon the evaluation based upon level 2 factors 108, the outsourced resource is onsite 110, the outsourced resource is offshore 112, or the resource is an FTE hire 114.

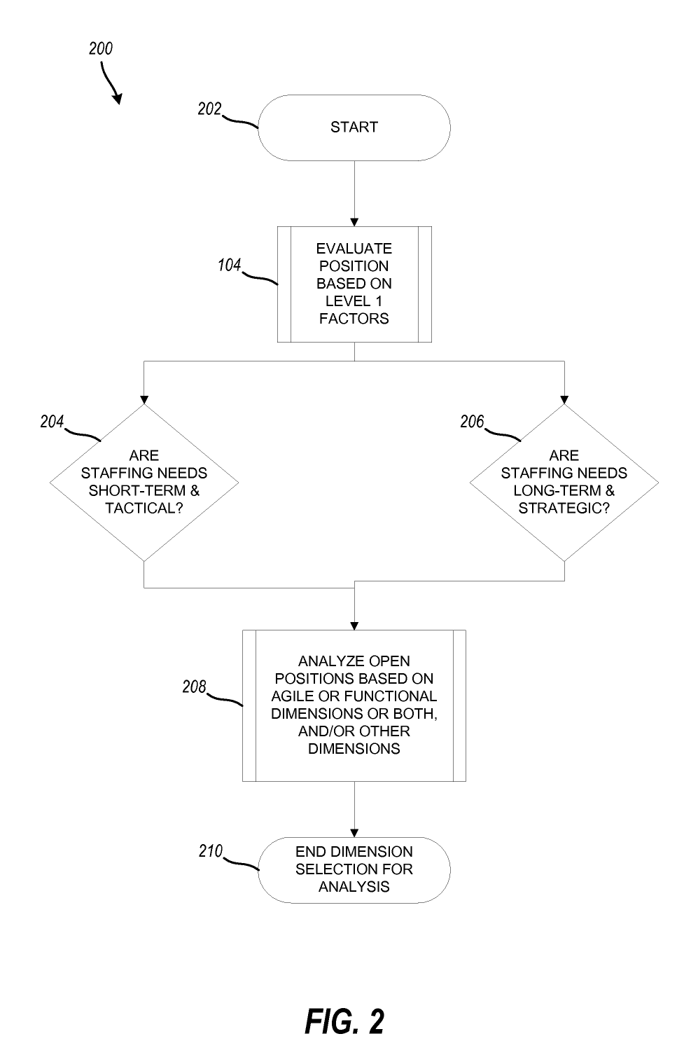

Referring now to FIG. 2, a multidimensional analysis 200 for evaluating sourcing potential is shown. The multidimensional analysis 200 is used in an interactive toolkit in at least one embodiment of the technology. To start 202 the evaluation of any position within the company based upon level 1 factors 104, the basis of a company's staffing needs is analyzed. For example, “Are the staffing needs short term and tactical?” 204 or “Are the staffing needs long-term and strategic?” 206. Based on answers to these inquiries, a company is better suited to further analyze additional factors pertaining to the position. The positions are analyzed 208 based upon the agile, functional, or both dimensions before ending 210. As is apparent to those of ordinary skill in the art, other dimensions are added to this two-tiered analysis as required to properly evaluate sourcing for a business.

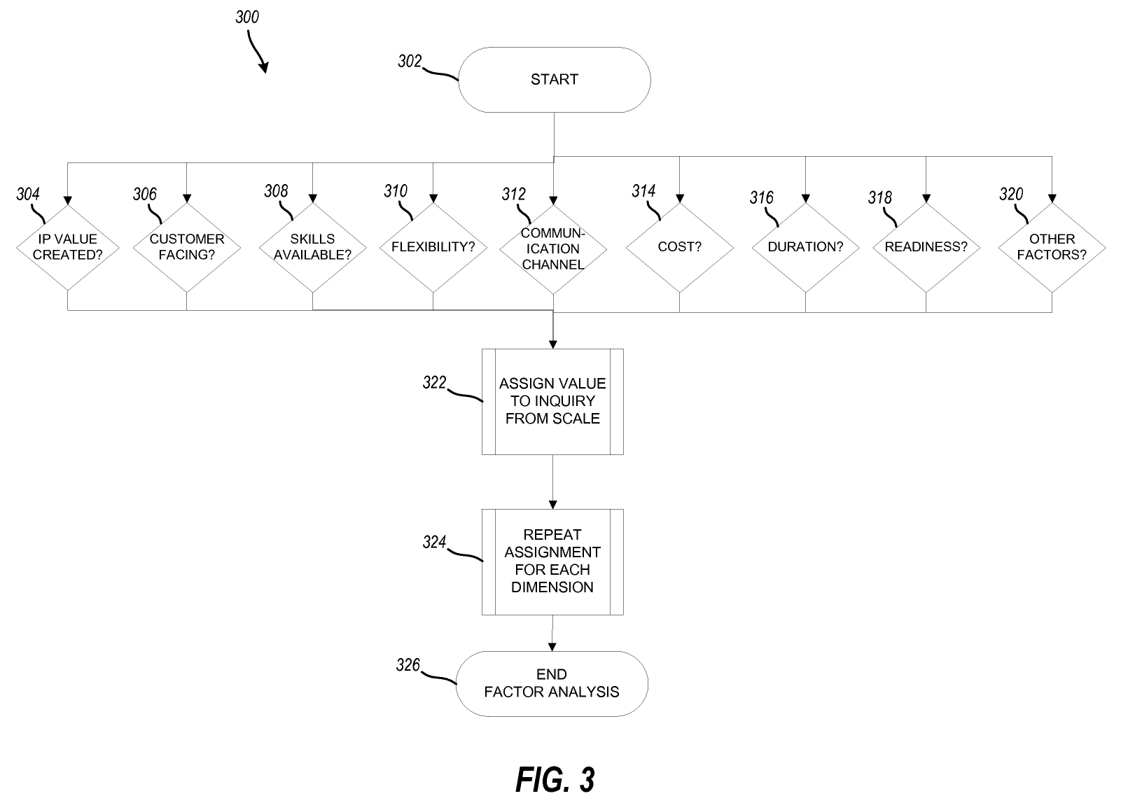

Referring now to FIG. 3, a multi-factor analysis 300 for evaluating sourcing potential is shown. The factors analysis 300 is used in an interactive toolkit in at least one embodiment of the technology. To start 302 the evaluation of any position within the company based upon level 2 factors, a number of inquiries are made.

The followings examples provided are exemplary. Other factors are utilized in alternative embodiments. “Does the activity of the position create any intellectual property value for the business?” 304 “Do the activities of the position require frequent face-to-face meetings and interactions?” 306 “Are the required skills for the position available locally?” and “Are the required skills for the position available offshore?” 308 “What is the demand by applicants to fill this position?” 310 “What are the most frequent communications channels required for this position?” 312 “Is cost a significant business driver to fill this position?” 314 “Is the duration of the position for a short-term, such as less than six months?” 316 “Does the business infrastructure allow services to readily be tasked offshore?” 318 “Are there additional factors to be considered?” 320

During the inquiry phase, 304 through 320, of the factors analysis, a value is assigned to each factor from a scale 322. The inquiry phase, including 304 through 320, of the factors analysis and the assignment of a value is repeated 324 for each dimension analyzed. The multi-factor analysis 300 ends 326 once all factors have been reviewed for each dimension being analyzed.

The technology described herein can be realized in whole or in part on an information processing system, such as a personal computer and/or a server. The processes previously described and shown in the flowchart diagrams herein can be carried out by executing instructions contained in a computer-readable medium and read by the information processing system.

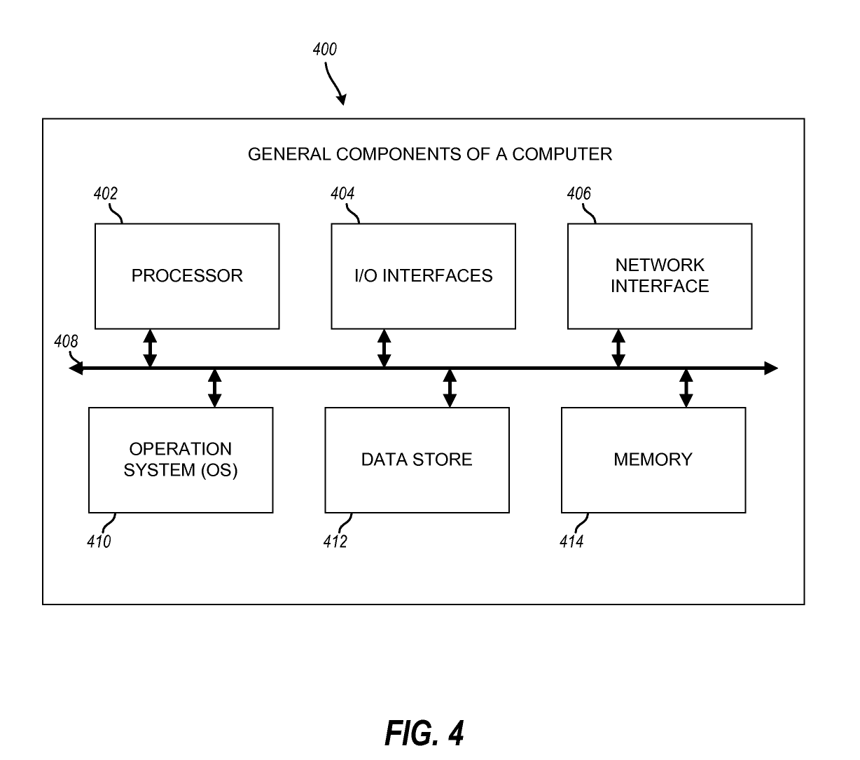

Referring now to FIG. 4, a block diagram 400 illustrating the general components of a computer is shown. The computer 400 can be a digital computer that, in terms of hardware architecture, generally includes a processor 402, input/output (I/O) interfaces 404, network interfaces 406, an operating system (O/S) 410, a data store 412, and a memory 414. The components (402, 404, 406, 410, 412, and 414) are communicatively coupled via a local interface 408. The local interface 408 can be, for example but not limited to, one or more buses or other wired or wireless connections, as is known in the art. The local interface 408 can have additional elements, which are omitted for simplicity, such as controllers, buffers (caches), drivers, among many others, to enable communications. Further, the local interface 408 can include address, control, and/or data connections to enable appropriate communications among the aforementioned components. The general operation of a computer comprising these elements is well known in the art.

The processor 402 is a hardware device for executing software instructions. The processor 402 can be any custom made or commercially available processor, a central processing unit (CPU), an auxiliary processor among several processors associated with the computer 400, a semiconductor-based microprocessor (in the form of a microchip or chip set), or generally any device for executing software instructions. When the computer 400 is in operation, the processor 402 is configured to execute software stored within the memory 414, to communicate data to and from the memory 414, and to generally control operations of the computer 400 pursuant to the software instructions.

The I/O interfaces 404 can be used to receive user input from and/or for providing system output to one or more devices or components. User input can be provided via, for example, a keyboard and/or a mouse. System output can be provided via a display device and a printer (not shown). I/O interfaces 404 can include, for example but not limited to, a serial port, a parallel port, a small computer system interface (SCSI), an infrared (IR) interface, a radio frequency (RF) interface, and/or a universal serial bus (USB) interface.

The network interfaces 406 can be used to enable the computer 400 to communicate on a network. For example, the computer 400 can utilize the network interfaces 408 to communicate via the internet to other computers or servers for software updates, technical support, etc. The network interfaces 408 can include, for example, an Ethernet card (e.g., 10BaseT, Fast Ethernet, Gigabit Ethernet) or a wireless local area network (WLAN) card (e.g., 802.11a/b/g). The network interfaces 408 can include address, control, and/or data connections to enable appropriate communications on the network.

A data store 412 can be used to store data, such as information regarding positions entered in a requisition. The data store 412 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 412 can incorporate electronic, magnetic, optical, and/or other types of storage media. In one example, the data store 412 can be located internal to the computer 400 such as, for example, an internal hard drive connected to the local interface 408 in the computer 400. Additionally in another embodiment, the data store can be located external to the computer 400 such as, for example, an external hard drive connected to the I/O interfaces 404 (e.g., SCSI or USB connection). Finally in a third embodiment, the data store may be connected to the computer 400 through a network, such as, for example, a network attached file server.

The memory 414 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 414 may incorporate electronic, magnetic, optical, and/or other types of storage media. Note that the memory 414 can have a distributed architecture, where various components are situated remotely from one another, but can be accessed by the processor 402.

The software in memory 414 can include one or more software programs, each of which includes an ordered listing of executable instructions for implementing logical functions. In the example of FIG. 4, the software in the memory system 414 includes the interactive toolkit for sourcing valuation and a suitable operating system (O/S) 410. The operating system 410 essentially controls the execution of other computer programs, such as the interactive toolkit for sourcing valuation, and provides scheduling, input-output control, file and data management, memory management, and communication control and related services. The operating system 410 can be any of Windows NT, Windows 2000, Windows XP, Windows Vista (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C.), or other like operating system with similar functionality.

In an exemplary embodiment of the technology described herein, the computer 400 is configured to perform flowcharts 100, 200, and 300 depicted in FIGS. 1, 2, and 3 respectively. The interactive toolkit for sourcing valuation located on computer 400 is configured specifically to perform these tasks. The interactive toolkit for sourcing valuation is user-driven in a questionnaire style that coaches the user throughout the sourcing valuation exercise. The interactive toolkit for sourcing valuation is configurable per user. However, it should be noted that a computer 400 is not necessary for realizing the technology described herein.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A computer readable storage medium encoded with programming for interactively analyzing sourcing options for positions within an organization in multiple dimensions, the computer readable medium with programming configured to:
receive a requisition identifying a position within an organization that is to be filled;
evaluate the position based upon a first series of business factors;
inquire whether the position requires a full-time employee;
evaluate the position based upon a second series of business factors;
rank the first series of business factors and the second series of business factors on a predetermined scale to quantify an impact to the organization for each factor;
calculate a single numerical value representative of the rank of each of the first series of business factors and the second series of business factors;
compare the calculated value with a predetermined benchmark to determine a suitable sourcing option; and
fill the position from a plurality of sourcing options based upon a result of the multidimensional, interactive sourcing analysis.

2. The computer readable storage medium encoded with programming for interactively analyzing sourcing options for positions within an organization in multiple dimensions of claim 1, wherein the first series of business factors comprises short-term, tactical drivers and long-term, strategic drivers.

3. The computer readable storage medium encoded with programming for interactively analyzing sourcing options for positions within an organization in multiple dimensions of claim 1, wherein the second series of business factors comprises intellectual property, customer facing, availability of skills in the local marketplace, flexibility, communications channels utilized, cost, duration, and organization readiness to procure externally sourced candidates.

4. The computer readable storage medium encoded with programming for interactively analyzing sourcing options for positions within an organization in multiple dimensions of claim 1, wherein the programming is further configured to:
utilize an interactive, on-screen interview questionnaire.

5. The computer readable storage medium encoded with programming for interactively analyzing sourcing options for positions within an organization in multiple dimensions of claim 4, wherein the programming is further configured to:
coach a user as the user responds to the interactive, on-screen interview questionnaire.

6. The computer readable storage medium encoded with programming for interactively analyzing sourcing options for positions within an organization in multiple dimensions of claim 1, wherein the programming is reconfigurable on a per-client basis.

7. The computer readable storage medium encoded with programming for interactively analyzing sourcing options for positions within an organization in multiple dimensions of claim 1, wherein the programming is further configured to:
allow the addition of one or more first series of business factors interactively by a user based on a particular organization business driver currently unaddressed.

8. The computer readable storage medium encoded with programming for interactively analyzing sourcing options for positions within an organization in multiple dimensions of claim 1, wherein the programming is further configured to:
allow the addition of one or more second series of business factors interactively by a user based on a particular organization business driver currently unaddressed.

9. The computer readable storage medium encoded with programming for interactively analyzing sourcing options for positions within an organization in multiple dimensions of claim 1, wherein the programming is further configured to:
allow the resealing, by a user, of the predetermined scale used to quantify each factor's impact to the organization, in response to business drivers.

10. The computer readable storage medium encoded with programming for interactively analyzing sourcing options for positions within an organization in multiple dimensions of claim 1, wherein the programming is further configured to:
allow the reconfiguration, by a user, of the predetermined benchmark used determine a suitable sourcing option, in response to business drivers.

11. The computer readable storage medium encoded with programming for interactively analyzing sourcing options for positions within an organization in multiple dimensions of claim 1, wherein the programming is further configured to:
calculate a single numerical value representative of the rank of each of the first series of business factors and the second series of business factors utilizing weighted averages; and
accept and review user-entered weighted values for each of the first series of business factors and the second series of business factors.

12. A method for evaluating outsourcing potential and interactively analyzing sourcing options for positions within an organization, the method comprising:
receiving a requisition identifying a position within an organization that is to be filled;
evaluating the position based upon a first series of business factors;
inquiring whether the position requires a full-time employee;
evaluating the position based upon a second series of business factors;
ranking the first series of business factors and the second series of business factors on a predetermined scale to quantify an impact to the organization for each factor;
calculating a single numerical value representative of the rank of each of the first series of business factors and the second series of business factors;
comparing the calculated value with a predetermined benchmark to determine a suitable sourcing option; and
filling the position from a plurality of sourcing options based upon a result of the multidimensional, interactive sourcing analysis.

13. The method for evaluating outsourcing potential and interactively analyzing sourcing options for positions within an organization of claim 12, the method further comprising:
utilizing a sourcing valuation algorithm residing in a computer program product to analyze sourcing options.

14. The method for evaluating outsourcing potential and interactively analyzing sourcing options for positions within an organization of claim 12, the method further comprising:
utilizing an interactive, on-screen interview questionnaire.

15. The method for evaluating outsourcing potential and interactively analyzing sourcing options for positions within an organization of claim 14, the method further comprising:
coaching a user as the user responds to the interactive, on-screen interview questionnaire.

16. The method for evaluating outsourcing potential and interactively analyzing sourcing options for positions within an organization of claim 12, the method further comprising:
rescaling, by a user, the predetermined scale used to quantify each factor's impact to the organization, in response to business drivers.

17. The method for evaluating outsourcing potential and interactively analyzing sourcing options for positions within an organization of claim 12, the method further comprising:
reconfiguring, by a user, the predetermined benchmark used determine a suitable sourcing option, in response to business drivers.

18. The method for evaluating outsourcing potential and interactively analyzing sourcing options for positions within an organization of claim 12, the method further comprising:
calculating a single numerical value representative of the rank of each of the first series of business factors and the second series of business factors utilizing weighted averages; and
accepting and reviewing user-entered weighted values for each of the first series of business factors and the second series of business factors

19. A computer program product for interactively analyzing sourcing options for positions within an organization, the computer program product comprising:
a computer readable storage medium readable by a processor of a computer and configured to store instructions for execution by the processor for performing a method comprising:
receiving a requisition identifying a position within an organization that is to be filled;
evaluating the position based upon a first series of business factors;
inquiring whether the position requires a full-time employee;
evaluating the position based upon a second series of business factors;
ranking the first series of business factors and the second series of business factors on a predetermined scale to quantify an impact to the organization for each factor;
calculating a single numerical value representative of the rank of each of the first series of business factors and the second series of business factors;
comparing the calculated value with a predetermined benchmark to determine a suitable sourcing option; and
filling the position from a plurality of sourcing options based upon a result of the multidimensional, interactive sourcing analysis.

20. The computer program product for interactively analyzing sourcing options for positions within an organization of claim 19, the computer program product further comprising:
logic configured to interview and coach a user with an interactive, on-screen interview questionnaire.
